(19) United States
(12) Patent Application Publication
(10) Pub. No.: US 2019/0255927 A1
(43) Pub. Date: Aug. 22, 2019

(54) SOLAR INTEGRATED SUN SHADE SYSTEM WITH SURVEILLANCE FOR AN AUTOMOBILE

(71) Applicant: Jean Edrice Georges, Boynton Beach, FL (US)

(72) Inventor: Jean Edrice Georges, Boynton Beach, FL (US)

(21) Appl. No.: 16/278,664

(22) Filed: Feb. 18, 2019

Related U.S. Application Data
(60) Provisional application No. 62/631,644, filed on Feb. 17, 2018.

(51) Int. Cl. B60J 11/08; B60R 25/30; F24F 5/00; B60H 1/00; B60J 1/20

(52) U.S. Cl. CPC B60J 11/08; B60R 25/305; F24F 2005/0064; B60H 1/00264; B60J 1/2011; F24F 5/0046

(57) ABSTRACT

A sun shade in the form of cover, manual or automatic, made of reflective or any other fabrics and non-ferrous materials, made in whole or in multiple pieces to fully or partially cover the whole or top part of a vehicle as to reduce the effect of heat waves affecting automobile's inside and outside, having a camera on top and a portable fans inside said vehicle that are powered by over the top solar panels first to monitor and capture surrounding activities, second to recirculate congested air inside said automobile, and then to power any other portable accessories inside said vehicle.

### CROSS REFERENCE TO RELATED APPLICATIONS

This application is also based on provisional application Ser. No. 62/631,944 filed on Feb. 19, 2018
INVENTOR: Jean Edrice Georges

### FIELD OF THE INVENTION

The present invention relates generally to the field of automotive accessories; more particularly to a solar integrated sunshade system with surveillance for a vehicle, intended to prevent the sun heat from affecting the vehicle's inside temperature while at the same time provides means to maintain not only a more comfortable temperature environment inside the vehicle, but also to monitor its surrounding while parked.

### BACKGROUND OF THE INVENTION

Sun shades for automobiles are known in the art. For example, a commonly used product is a foldable sun shade that is placed against a windshield on the interior of a car. The sun shade is supposed to keep the interior of the car protected from sunlight. Thus, the sun shade may be used to protect the portions of the dashboard that are exposed to direct sunlight and/or to keep the car cool during hot weather.

Some sun shades of the prior arts use suction cups to stick to the interior surface of the windshield. Others use straps or ties which attach to the rear-view mirror or some another portion on the interior of the automobile. Before exiting an automobile, a user must press each suction cup firmly against the windshield or secure every strap such that the sun shade is properly in place.

The drawbacks to such sun shades are numerous. Firstly, the sun shades of the prior art are often difficult to apply, requiring a user to tediously ensure that the suction cups are properly stuck or the straps properly applied. Furthermore, the sun shades may not completely abut the entire surface of the windshield, thereby leaving gaps which are at the mercy of the sun's rays. Temperature and other conditions may cause suction cups and/or adhesives to become unstuck and unusable.

Furthermore, all the sun shades that are on the market have one bad thing in common: a heavy, dangerous, and unhealthy heat wave is likely to welcome you the moment you open the door after the car was parked in the sun for a long period of time.

Therefore, there is a need in the art to provide a better sun shade that can significantly reduce the heat not only to just one windshield but also to most part of the automobile, including its current inside air condition.

### SUMMARY OF THE INVENTION

Therefore, it is an object of the disclosed technology to find a functional sun shade that does not require a great deal of effort to apply.

As such, in an embodiment of the disclosed technology, a sun shade or system of shades is used for limiting the outside heat from affecting the automobile's inside temperature while maintaining a more desirable condition. Such a device or system is laid on the outer top of an automobile having a front end that cover front windshield, two sides that covers side windows, a middle section to include solar panels, a back end that covers back windshield, and a covered chunk.

The sun shade is generally formed of three members, joined either together or made in whole, and complemented with solar panels to power an over-the top cameras monitoring system, and (or) an automobile's interior air recycling fans system. An elongated front member has a wide front cover, and is adapted for placement at a top of the windshield.

It then continues with the elongated middle section which covers the very top portion of the automobile and the sides doors with windows.

The other wide back end piece is adapted for placement at a top back windshield and end over the vehicle's trunk cover, completing a fully hidden top of the vehicle usually exposed to sun heat.

One primary object of the invention is to provide a true comprehensive sun shade system that blocks sun heat from the two main windshields front and back, and from the two sides.

Another object of the invention is to provide a sun shade that also protects the top metal part of the automobile from transferring too much heat inside while also protecting the paint from fading.

It is yet another object of the vehicle to provide a sun shade that blocks the heat wave from coming from the side windows.

It is also an object of the present invention to provide means to verify the inside/outside temperature with/without humidity of a vehicle from the outside while said sun shade is in use.

Still, it is another object of the invention to provide a sun shade not just to protect the outer parts of an automobile from direct sun light, but also to recirculate the current congested air inside the automobile.

Another object of this invention is to provide a way for a vehicle to be used as a mean for a mobile or portable surveillance system which can be parked and placed anywhere.

Again, another object of the invention is to provide a sun shade with means to record, capture, and monitor a parked automobile's surrounding activities through wireless cameras.

Another object of the invention is to still provide a solar/battery powered wireless monitoring mean to an automobile during spring and fall seasons when outside sun heat is not considered a big concern.

It is another object of the invention to provide a battery powered wireless monitoring system for an automobile that can be used at night using night vision technology.

Finally, it is an object of the invention to provide a sun shade with surveillance system that can be used year around.

Further objects of the invention will be brought out in the following part of the specification, wherein detailed description is for fully disclosing the invention without placing limitations thereon.

### BRIEF DESCRIPTION OF THE SEVERAL VIEWS OF THE DRAWING(S)

The drawings constitute a part of this specification and include exemplary embodiment to the invention, which may be embodied in various forms. It is to be understood that in some instances various aspects of the invention may be shown exaggerated or enlarged to facilitate an understanding of the invention.

With the above and other related objects in view, the invention consists in the details of construction and combination of parts as will be more fully understood from the following description, when read in conjunction with the accompanying drawings in which:

FIG. 1 illustrates the view of an automobile's half sun shade with magnet buttons.

FIG. 2 illustrates a sectional view of a covered magnet button.

FIG. 3 illustrates the view of an automobile's half sun shade under layer for wires patch.

FIG. 4 illustrates an automobile's half sun shade assembled with its under layer.

FIG. 5 illustrates automobile's top half sun shade and its under layer being assembled with solar panels and a surveillance camera.

FIG. 6 illustrates automobile's top half sun shade being wired and connected with accessories located inside vehicle.

FIG. 7 illustrates a diagram that includes all the elements that constitutes automobile's top half sun shade system.

FIG. 8 illustrates the back seats of an automobile showing one or more fans being powered by solar panels located on top of automobile's half sun shade.

FIG. 9 illustrates a fully equipped automobile's top half sun shade viewing from the top.

FIG. 10 illustrates a side view of automobile's top half sun shade showing in FIG. 1.

FIG. 11 illustrates a top view of a full automobile's top half sun shade with all the components and covers the whole vehicle.

FIG. 12 illustrates a side view of a full automobile's top half sun shade in FIG. 11

FIG. 13 illustrates an extended version of the sun shade where other sections of the car can be selected and covered when needed, in addition to the top part.

FIG. 13A illustrates a top view layout of a full automobile's sun shade with its middle part ready to receive a separate or detachable half car sunshade.

FIG. 13B illustrates a top view of a half cover ready to be assembled with a full sun shade cover.

FIG. 13C illustrates a top view of the two covers fully assembled.

FIG. 13D illustrates a top view of the combined full sun shade covers in use.

FIG. 13E illustrates a side view of the combined full sun shade covers in use.

FIG. 14 illustrates a trimmed version of the sun shade system for off season use, with solar panels being wired and connected with accessories located inside the car.

FIG. 15 illustrates the side view of the off-season version of the sun shade system in use.

FIG. 16 illustrates the top view of the off-season version of the sun shade system in use.

FIG. 17 illustrates a side view of the off-season version of the sun shade system in use.

FIG. 18 illustrates the off-season version of the sun shade in use while placed over a car's chunk's cover.

### DETAILED DESCRIPTION OF THE INVENTION

The present invention now will be described more fully hereinafter with reference to the accompanying drawings, in which some, but not all embodiment of the invention is shown. Indeed, these inventions may be embodied in many different forms and should not be construed as limited to the embodiment set forth herein; rather, these embodiments are provided so that this disclosure will satisfy applicable legal requirements. Like numbers refer to like elements throughout.

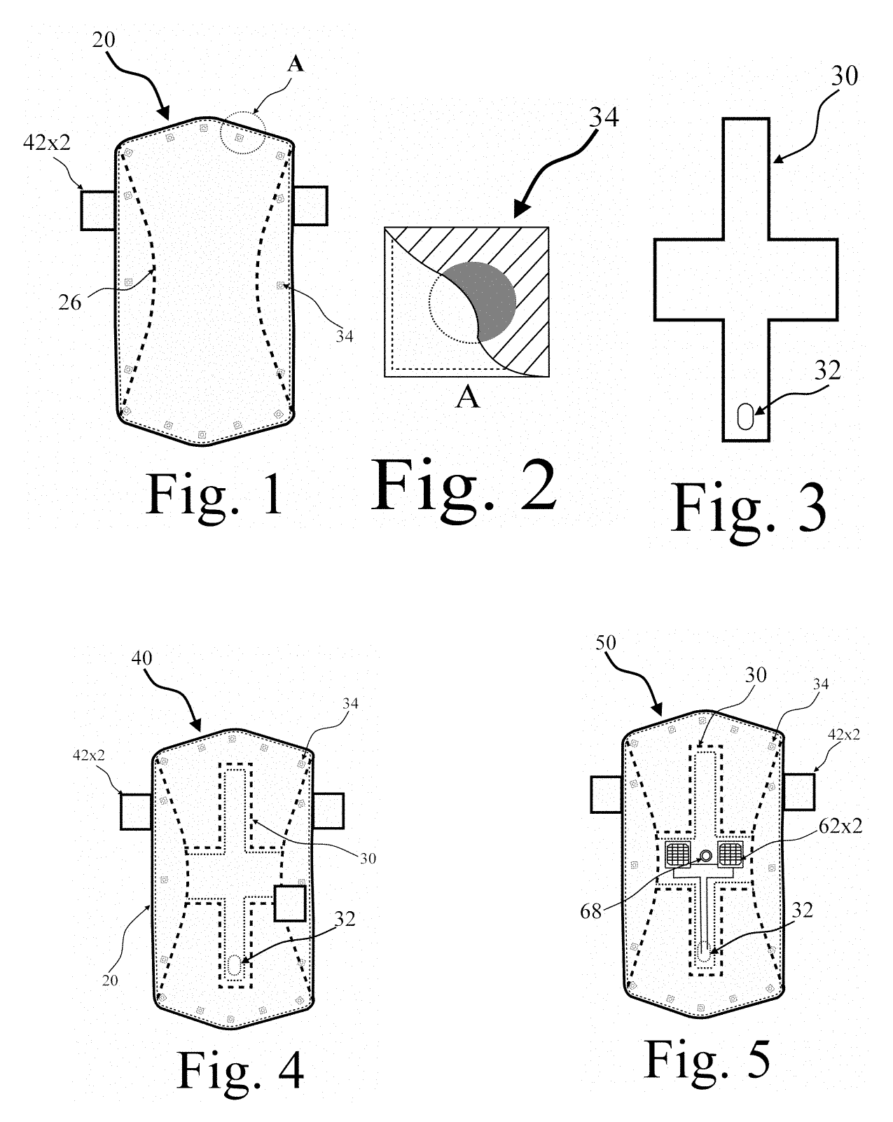

The present invention will now be described by referencing the appended figures representing preferred embodiment. Referring to FIG. 1, sun shade 20 is made from any fabrics or nonferrous materials. It includes two pockets 42, designed to receive vehicle's outside view mirrors. Several magnets 34 are located around sun shade 20, also detailed in FIG. 2, are to secure shade 20 in place around automobile and to prevent such shade from being easily thrown out by the wind.

Referring to FIG. 3, an under layer 30 may be necessary as to isolate the top of the automobile from wires for solar panels and other wired accessories. A wire exits 32 is created to allow passage of connecting wires from under sun shade 20 into chunk. Also, fabric strips (not shown) can be used for that purpose as well.

Referring to FIG. 4, sun shade 40 and under layer 30 are being quilted. Once joined, they can be held together through sewing, gluing, or any other means, as shown.

Referring to FIG. 5, assembled sun shade 50 includes two solar panels 62 designed to supply power to all accessories located in the car, including a wireless camera 68 as shown.

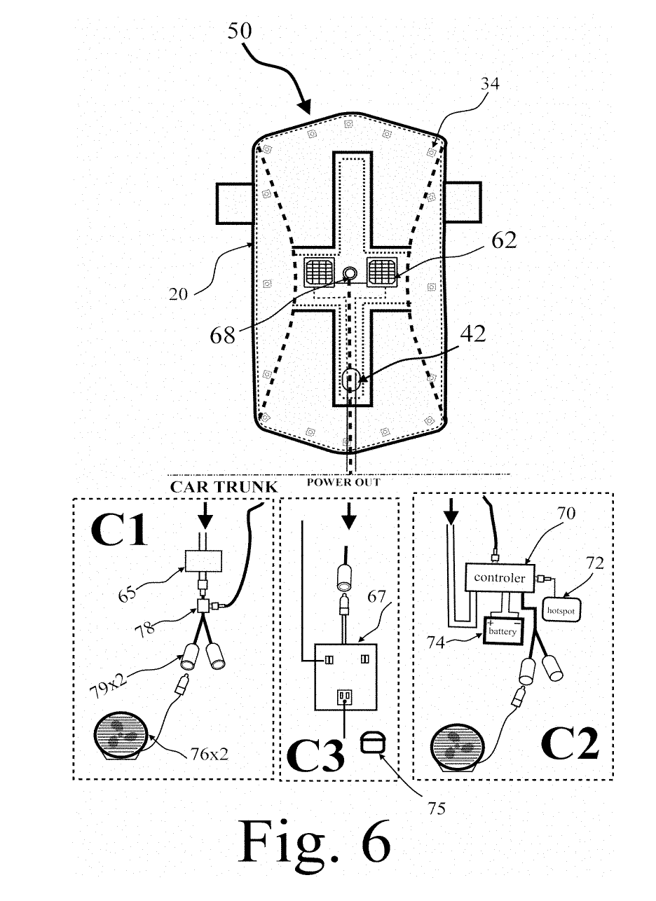

Referring to FIG. 6, output power of solar panels 62 of sun shade 50 connects to power convertor 65 which is connected to power distributor 78, to finally end into 5V/12V/24V or higher output terminals 79 to power a 5V, 12V, 24V or higher devices such as fans 76 and wireless camera 68 as shown in section C1.

Referring to FIG. 6 again, output power of solar panels 62 of sun shade 50 inters solar power controller 70 to charge battery 74, then out to power fans 76, hot spot 72, and camera 68, as shown in section C2.

Again, referring to FIG. 6, output power of solar panels 62 of sun shade 50 inters power inverter 67, out to 120V/420V (more or less) cooler/ice maker 75 and camera 68, or others, as shown in section C3.

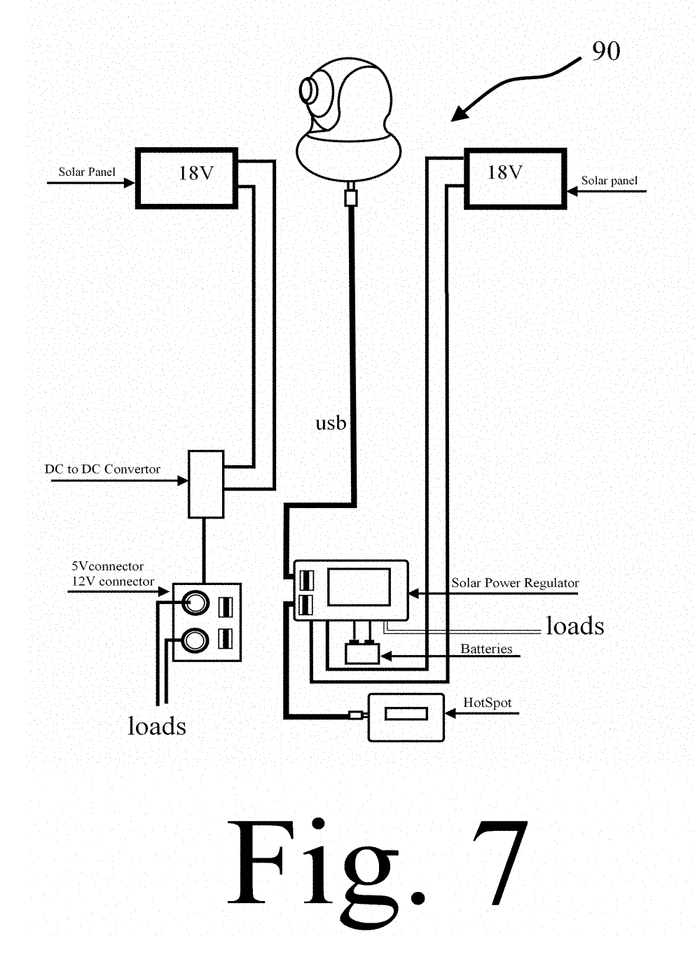

Referring to FIG. 7, diagram 90 displays two main possible lays outs that can be existed simultaneously in the operation of the sun shade system, having two separate sources of power.

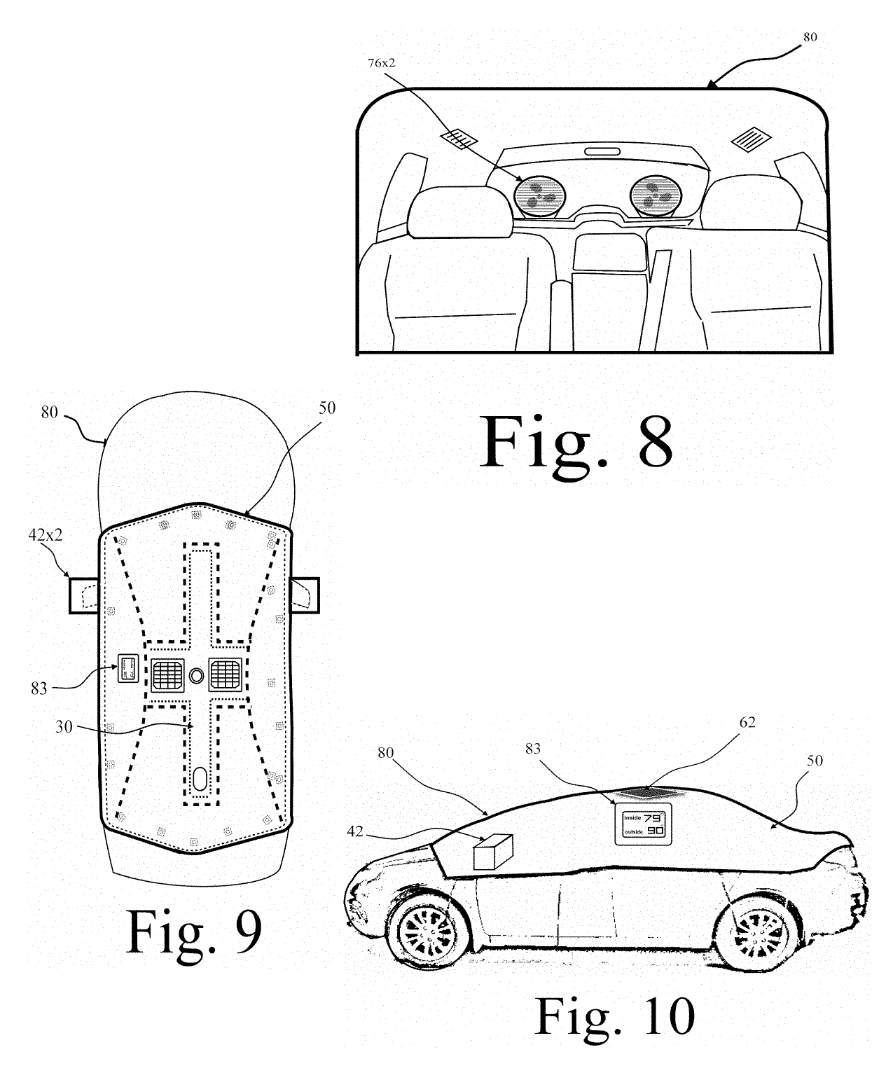

Referring to FIG. 8, behind back seat of inside car 80 are two fans 76 in operation, powered by solar panels 62 (not shown).

Referring to FIG. 9, top half sun shade's cover 50 in use over vehicle 80. Notice that sun shade 50 also includes temperature display 83 which displays current inside/outside shaded vehicle temperature.

Referring to FIG. 10, top half sun shade's cover 50 over vehicle 80, showing temperature display 83, and solar panel 62.

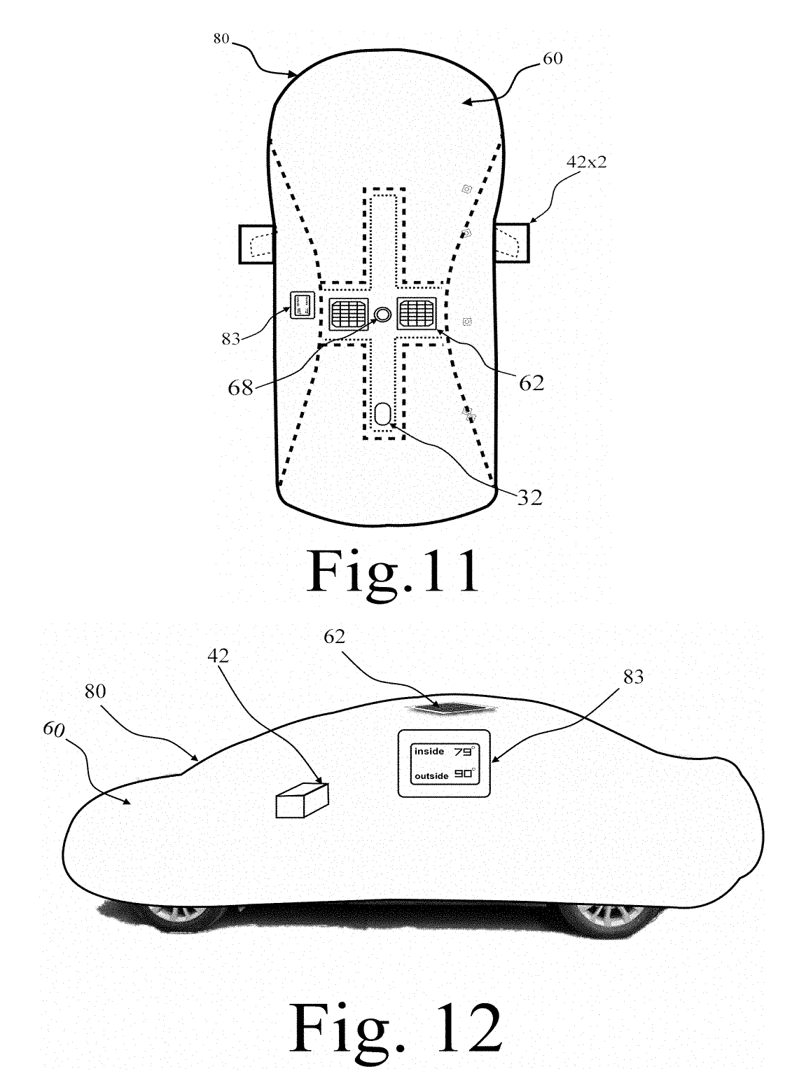

Referring to FIG. 11, full automobile sun shade 60 covers vehicle 80 showing temp display 83, outside mirror pockets 42, solar panels 62 and camera 68, viewing from the top.

Referring to FIG. 12, full automobile sun shade 60 covers vehicle 80 showing temp display 83, outside mirror pockets 42, solar panels 62 and camera 68, viewing from the side.

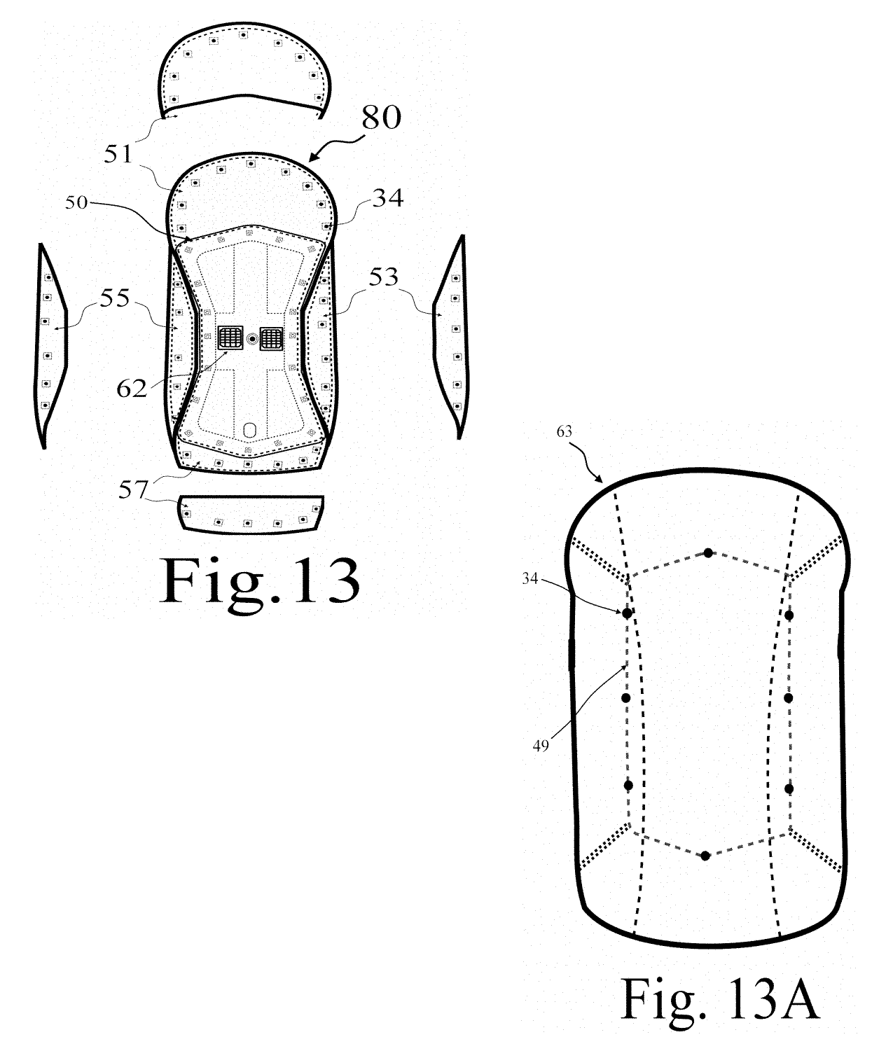

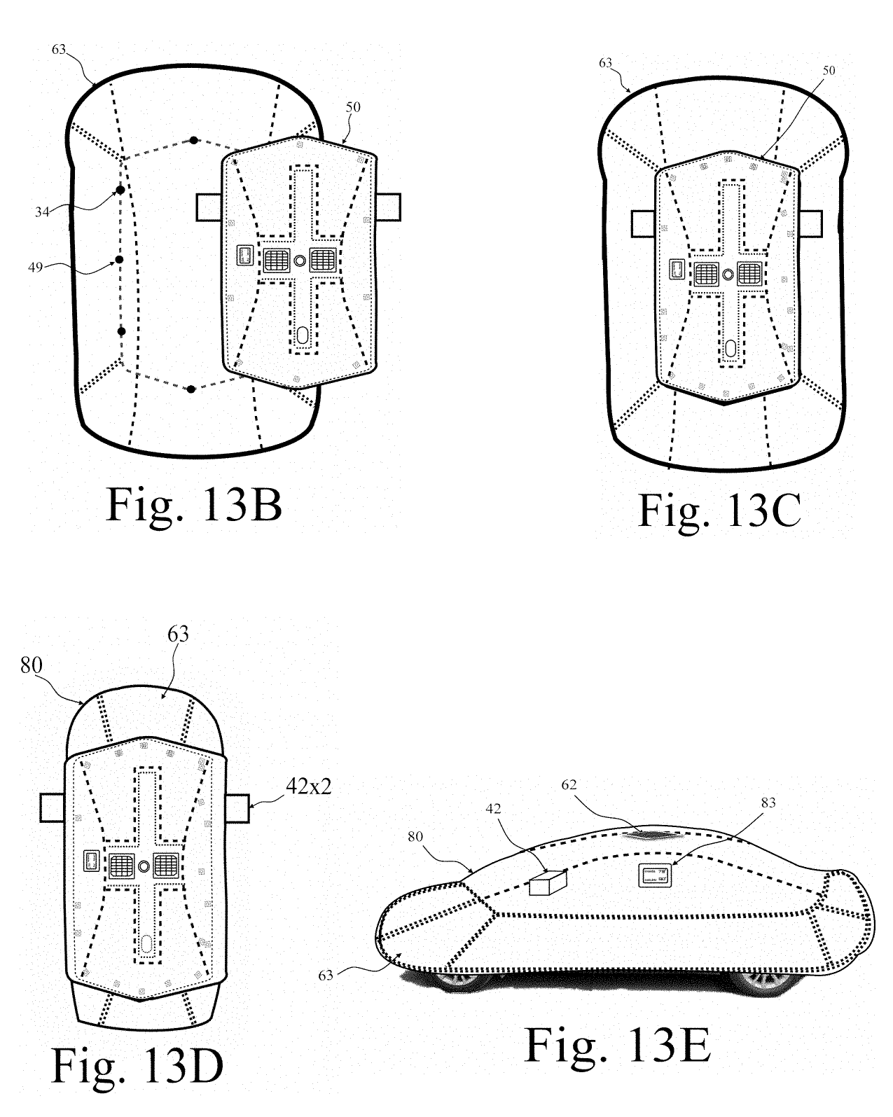

Referring to FIG. 13, vehicle 80 is covered by top sun shade's middle section 50, sides 53 and 55 covers side windows, front end is covered by section 51 while back end is covered by section 57

Referring to FIG. 13A, full sun shade's cover 63 to be combined with half top 50 is made of full cover 60, multiple magnets 25 to provide a lay out 49 to receive half top cover 50.

Referring to FIG. 13B, top half sun shade 50 is set to assemble over full sun shade 63 through corresponding magnets 34.

Referring to FIG. 13C, top half sun shade 50 and full sun shade 63 assembled together to become one unit.

Referring to FIG. 13D, full sun shade 63 is in use over vehicle 80 viewing from the top.

Referring to FIG. 13E, full sun shade 63 is in use over vehicle 80 showing mirror cover 42, solar panels 62, temp control 83, viewing from the side.

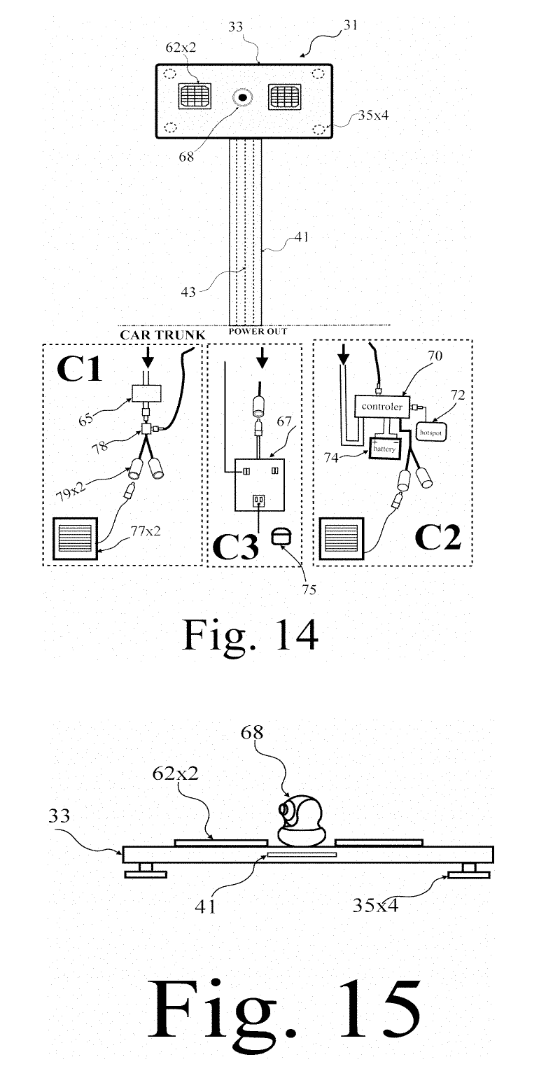

Referring to FIG. 14, trimmed sun shade 31, laying over for tabs 35, includes pad 33, solar panels 62 and camera 68, with wire 43 out through strip 41 to power convertor 65 which is connected to power distributor 78, to finally end into 5V/12V/24V (or higher) output terminals 79 to power a 5V, 12V, 24V (or higher voltage), such as car heaters 77 and wireless camera 68 as shown in section C1.

Referring again to FIG. 14, trimmed sun shade 31, laying over for tabs 35, includes pad 33, solar panels 62 and camera 68, with wire 43 out through strip 41, inters solar power controller 70 to charge battery 74, then out to power car heaters 77, hot spot 72, and camera 68, as shown in section C2.

Referring again to FIG. 14, trimmed sun shade 31, laying over for tabs 35, includes pad 33, solar panels 62 and camera 68, with wire 43 out through strip 41, inters power inverter 67, out to 120V/420V (more or less) cooler/ice maker 75 and camera 68, or others, as shown in section

C3.

Referring to FIG. 15, showing on top of pad 33 are solar panels 62, camera 68, power strip 41 and tabs 35 that support pad 33, viewing from the top.

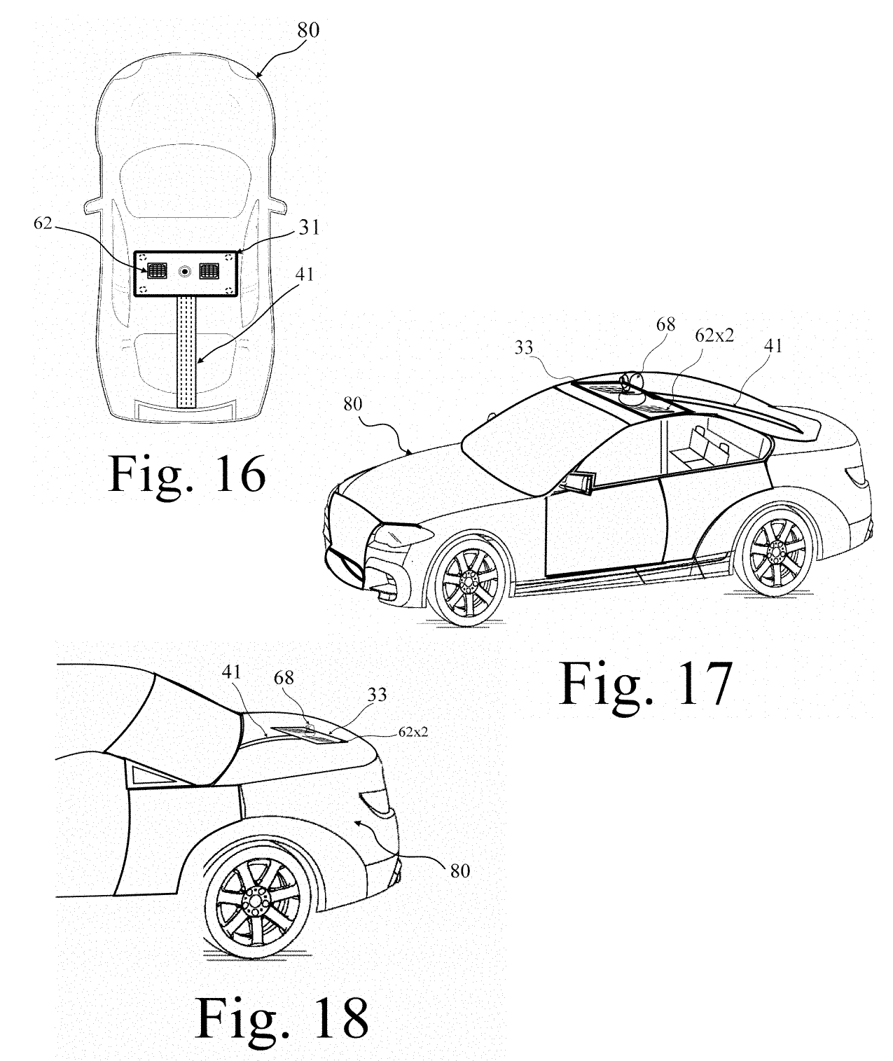

Referring to FIG. 16, pad 33 which includes solar panels 62, is placed on top of vehicle 80 having its power strip 41 going into car trunk (not shown) viewing from the top.

Referring to FIG. 17, pad 33 which includes solar panels 62, is placed on top of vehicle 80 having its power strip 41 going into car trunk (not shown), viewing from the side.

Referring to FIG. 18, pad 33 which includes solar panels 62, is placed on top of vehicle's chunk 80 having its power strip 41 going into trunk (not shown), viewing from the back.

What is claimed is:

1. A sun shade in the form of cover, manual or automatic, made of any fabrics or non-ferrous materials, made in whole, in half or in multiple pieces, to fully or partially cover a vehicle in whole or in part as to reduce the effect of heat waves in automobile's inside and outside, with means to recirculate air inside said automobile, means and means to self-monitor said vehicle's surrounding.

2. A sun shade in the form of cover, manual or automatic, made of any fabrics or non-ferrous materials, made in half or in multiple pieces to partially cover the top half portion of the vehicle, as to reduce the effect of heat waves in automobile's inside and on outside, to recirculate air inside said automobile, means to self-monitor said vehicle's surrounding, means to display said vehicle's inside and outside temperature while said display can be seen from outside said vehicle.

3. A sun shade in the form of cover, manual or automatic, made of any fabrics or non-ferrous materials, made in two parts: first in whole and second in half, used in combination to fully cover the whole vehicle as to reduce the effect of heat waves in automobile's inside and outside, or in part to simply protect top half of said automobile against heat waves with means to recirculate the air inside said automobile and means to self-monitor said vehicle's surrounding.

4. A sun shade in the form of cover, manual or automatic, made of any fabrics or non-ferrous materials, made in whole, in half or in multiple pieces to fully or partially cover whole or top part of an vehicle as to reduce the effect of heat waves in automobile's inside and on outside, with

5. A sun shade in the form of cover, manual or automatic, made of any fabrics or non-ferrous materials, made in half or in multiple pieces to partially cover top half portion of vehicle, as to reduce the effect of heat waves in automobile's inside and on outside, with means to display said vehicle's inside and outside temperature while said display can be seen from outside said vehicle.

6. The sun shade in claim 1 where a reduced version is used either by itself as a secondary car power accessory alternative used on parked or non-parked vehicles or to be placed over the top of a sun shade cover to provide necessary accommodation to accessories inside said parked vehicles. Such modified version of said sun shade includes all the components of a regular sun shade which provides means to capture low to medium solar power when available, means to use it to power wireless surveillance camera, to connect a car heather or any others.

7. The sun shade cover in claim 1 where solar panels are used over said cover to generate energy as to power car accessories such as, but not limited to, camera, portable fans, dehumidifier and de like, located over and/or inside said vehicle or car's trunk.

8. The sun shade cover in claim 2 where solar panels are used over said cover to generate energy as to power car accessories such as, but not limited to, camera, portable fans, dehumidifier and other necessary devices located over and/or inside said vehicle or car's trunk.

9. The sun shade cover in claim 1 where a portable personal hot spot is to be used to help connect to a camera located on top of said vehicle through Wi-fi when no other Wi-fi is available.

10. The sun shade in claim 2 where a portable personal hot spot is to be used to help connect to a camera, located on top of said vehicle, through Wi-fi when no other Wi-fi is available.

11. The sun shade in claim 1 where magnets and/or straps are used as to hold the cover in place and to protect it against winds and dust.

12. I claim, the product comprising any feature described, either individually or in combination with any feature, in any configuration.
